(19) United States
(12) Patent Application Publication
(10) Pub. No.: US 2025/0136791 A1
(43) Pub. Date: May 1, 2025

(54) COMPOSITE SHEET, METHOD FOR MANUFACTURING SAME AND HOME APPLIANCE INCLUDING SAME

(71) Applicant: LG ELECTRONICS INC., Seoul (KR)

(72) Inventors: Donghwan JEONG, Seoul (KR); Hyunwoo NOH, Seoul (KR); Hongseung DO, Seoul (KR); Kihyeong IM, Seoul (KR); Kuhyeong LEE, Seoul (KR)

(73) Assignee: LG ELECTRONICS INC., Seoul (KR)

(21) Appl. No.: 18/780,232

(22) Filed: Jul. 22, 2024

(30) Foreign Application Priority Data
Oct. 30, 2023 (KR) 10-2023-0147287

(51) Int. Cl. C08K 11/00; C08J 5/18

(52) U.S. Cl. CPC C08K 11/005; C08J 5/18; C08J 2300/22; C08K 2201/002

(57) ABSTRACT

A composite sheet, a method for manufacturing the composite sheet, and a home appliance including the composite sheet are discussed. The composite sheet can include a matrix including a base resin containing a thermoplastic material; and a plurality of chips including waste materials having irregular shapes, and coupled to the matrix. The plurality of chips are partially exposed to an outer surface of the composite sheet, and the sizes of the plurality of chips range from about 1 mm to about 3 cm, and a melting point temperature of the plurality of chips is about 200° C. or greater.

### CROSS-REFERENCE TO RELATED APPLICATIONS

Pursuant to 35 U.S.C. § 119 (a), this application claims the benefit of an earlier filing date and priority to Korean Application No. 10-2023-0147287, filed in the Republic of Korea on Oct. 30, 2023, the entire contents of which are hereby expressly incorporated by reference into the present application.

### BACKGROUND

### Field

The present disclosure relates to a composite sheet, a method for manufacturing the composite sheet, and a home appliance including the composite sheet.

### Discussion of the Related Art

Home appliances mainly refer to devices installed in a user's home to help the user with housework, and include refrigerators, air conditioners, air purifiers, vacuum cleaners, cooking devices, dishwashers, clothes care machines, washing machines, and the like.

Recently, home appliances with outer appearances incorporating design elements have been appearing. It has become important for home appliances to have a luxurious outer appearance that harmonizes with an interior decoration of the user's home as well as an original performance and intended function of the home appliances.

Meanwhile, as interest in the environment increases, up-cycling attempts are being made to increase value by applying eco-friendly materials made from recycled waste materials to product design, which can improve the home appliances' aesthetics and eco-friendliness at the same time and thus it is gaining attention in the market place for the home appliances.

### SUMMARY

An object of the present disclosure is to provide a composite sheet that can simultaneously improve aesthetics and eco-friendliness through the composite sheet using eco-friendly materials, a method for manufacturing the composite sheet, and a home appliance including the composite sheet.

An object of the present disclosure is to provide a composite sheet with excellent mechanical properties such as improved surface hardness, improved strength, and reduced coefficient of thermal expansion, a method for manufacturing the composite sheet, and a home appliance including the composite sheet.

An object of the present disclosure is to provide a composite sheet that includes chips formed of a highly heat-resistant material and can improve safety in the event of a fire, a method for manufacturing the composite sheet, and a home appliance including the composite sheet.

A composite sheet according to an embodiment to solve the above problem includes a matrix; and a plurality of chips surrounded by the matrix, at least a portion of which is exposed to the outside, in which the chip has an average size of 1 mm or more and 3 cm or less and a melting point of 200° C. or more.

The matrix can be a thermoplastic material.

The matrix can include at least one of PMMA, PC, ABS, PC, PET, PA, PP, and PS.

The chip can be formed by pulverizing waste materials.

The waste material can include artificial marble.

The waste material can include a material containing at least one of PEEK, PTFE, PAI, and PI.

The composite sheet can further include maleic anhydride, in which the waste material can include a thermosetting plastic containing at least one of phenol resin, melamine resin, epoxy resin, urea resin, unsaturated polyester resin, alkyd resin, silicon resin, and polyurethane resin.

The composite sheet can further include maleic anhydride, in which the waste material can include shell.

After extruding a mixture containing a base resin constituting the matrix and the chip into a sheet shape, the surface of the extruded sheet can be etched so that at least a portion of the plurality of the chips is exposed.

The number of chips exposed to the outside from the surface of the sheet can increase as the surface of the sheet is etched.

A method for manufacturing a composite sheet according to an embodiment to solve the above problem includes pulverizing waste materials with a melting point of 200° C. or higher to form chips with a size of 1 mm or more and 3 cm or less; dispersing the chips in a base resin to form a mixture; forming a sheet preform with the mixture; and etching the surface of the sheet preform so that at least a portion of the chip is exposed to the outside.

The base resin can be a thermoplastic material.

The base resin can include at least one of PMMA, PC, ABS, PC, PET, PA, PP, and PS.

The chips can be formed by pulverizing waste materials.

The waste material can include artificial marble.

The waste material can include a material containing at least one of PEEK, PTFE, PAI, and PI.

The waste materials can include thermosetting plastics containing at least one of phenol resin, melamine resin, epoxy resin, urea resin, unsaturated polyester resin, alkyd resin, silicon resin, and polyurethane resin, and the dispersing the chips in the base resin to form a mixture can further include adding maleic anhydride.

The waste materials can include shells, and the dispersing the chips in the base resin to form a mixture can further include adding maleic anhydride.

The etching the surface of the sheet preform can increase the number of chips exposed to the outside from the surface of the sheet preform.

A home appliance according to an embodiment to solve the above problem includes a cabinet forming storage space; a door configured to open and close the storage space; and a door cover coupled to a front of the door, in which the door cover includes the composite sheet of claim 1.

A composite sheet according to an embodiment to solve the above problem includes a matrix including a base resin which contains a thermoplastic material; and chips by pulverizing waste materials having irregular shapes and coupled by the matrix and the chips partially exposed to an outer surface of the composite sheet, in which a range of sizes of the chips has from 1 mm to 3 cm and a temperature of melting point of the chips has 200° C. over.

The matrix includes at least one of PMMA, PC, ABS, PC, PET, PA, PP, and PS.

The chip is formed by pulverizing waste materials.

The waste material includes artificial marble.

The waste material includes a material containing at least one of PEEK, PTFE, PAI, and PI.

The composite sheet can further include maleic anhydride, in which the waste material includes a thermosetting plastic containing at least one of phenol resin, melamine resin, epoxy resin, urea resin, unsaturated polyester resin, alkyd resin, silicon resin, and polyurethane resin.

The composite sheet can further include maleic anhydride, in which the waste material includes shell.

After extruding a mixture containing a base resin constituting the matrix and the chip into a sheet shape, the surface of the extruded sheet is cut so that at least a portion of the plurality of the chips is exposed.

The number of chips exposed to the outside from the surface of the sheet increases as the surface of the sheet is cut.

A method for manufacturing a composite sheet according to an embodiment to solve the above problem includes pulverizing waste materials with a temperature melting point of 200° C. over to form chips which have irregular shapes with a size range of 1 mm˜3 cm; mixing the chips in a base resin to form a mixture; manufacturing a sheet preform by heating the mixture; and cutting an outer surface of the sheet preform to partially expose the chips to an outer surface of the composite sheet.

The base resin is a thermoplastic material.

The base resin includes at least one of PMMA, PC, ABS, PC, PET, PA, PP, and PS.

The chips are formed by pulverizing waste materials.

The waste material includes artificial marble.

The waste material includes a material containing at least one of PEEK, PTFE, PAI, and PI.

The waste materials include thermosetting plastics containing at least one of phenol resin, melamine resin, epoxy resin, urea resin, unsaturated polyester resin, alkyd resin, silicon resin, and polyurethane resin, and the mixing the chips in the base resin to form a mixture further includes adding maleic anhydride.

The waste materials include shells, and the mixing the chips in the base resin to form a mixture further includes adding maleic anhydride.

The cutting the surface of the sheet preform increases the number of chips exposed to the outside from the surface of the sheet preform.

A home appliance according to an embodiment to solve the above problem includes a cabinet forming storage space; a door configured to open and close the storage space; and a door cover coupled to a front of the door, in which the door cover includes the composite sheet of claim 1.

The present disclosure can implement upcycling that simultaneously improves aesthetics and eco-friendliness through a composite sheet using eco-friendly materials.

The present disclosure can improve mechanical properties such as improving surface hardness, improving strength, and reducing thermal expansion coefficient of applied home appliances through a composite sheet structure including a matrix and a chip.

The present disclosure, through a composite sheet structure with improved heat resistance including chips formed of a highly heat-resistant material, can prevent products to which the composite sheet is applied from burning from heat in the event of a fire, thereby improving user safety.

### BRIEF DESCRIPTION OF THE DRAWINGS

FIG. 1 is a front view illustrating a home appliance according to one embodiment.

FIG. 2 is a cross-sectional view illustrating a composite sheet according to one embodiment.

FIG. 3 is a flowchart illustrating a method for manufacturing a composite sheet according to one embodiment.

FIG. 4 is a schematic diagram illustrating a process of casting a sheet preform according to one embodiment.

FIG. 5 is a schematic diagram illustrating the process of extruding a sheet preform according to one embodiment.

FIG. 6 is a cross-sectional view illustrating a sheet preform according to one embodiment.

### DETAILED DESCRIPTION OF THE EMBODIMENTS

Hereinafter, some embodiments of the present disclosure will be described in detail with reference to the accompanying drawings. It is noted that the same or similar components in the drawings are designated by the same reference numerals as far as possible even if they are illustrated in different drawings. In addition, in describing the embodiments of the present disclosure, if it is determined that a detailed description of a related known configuration or function disturbs understanding of the embodiment of the present disclosure, the detailed description will be omitted.

In addition, in the description of the embodiments of the present disclosure, the terms such as first, second, A, B, (a) and (b) can be used. These terms are only used to distinguish the component from other components, and the essence, sequence, or order of the corresponding component is not limited by the term. It should be understood that when an element is described as being “connected,” “coupled”, or “joined” to another element, the former can be directly connected or jointed to the latter or can be “connected”, coupled” or “joined” to the latter with a third component interposed therebetween.

For convenience of explanation and understanding, we would like to define direction. Hereinafter, based on the floor on which the home appliance 1 is installed, the direction toward the floor can be referred to as a downward direction, and the direction toward the high surface of the cabinet opposite to that can be referred to as an upward direction. Additionally, the direction toward the door can be referred to as the front direction, and the direction toward the inside of the cabinet based on the door can be referred to as the rear direction. In addition, when you want to talk about an undefined direction, you can define and explain the direction based on each drawing.

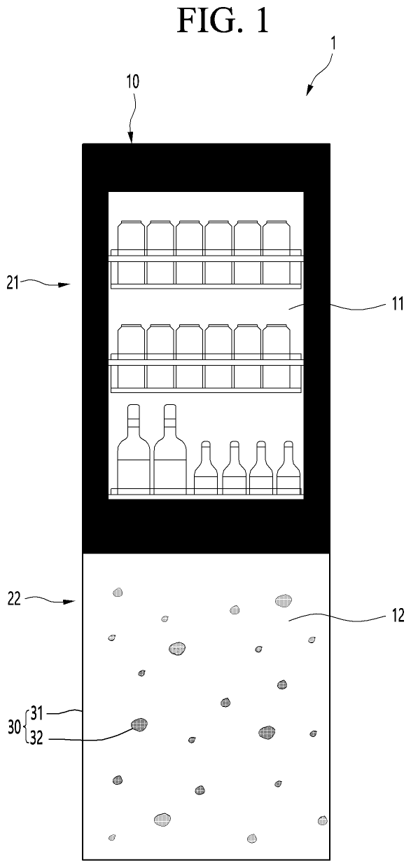

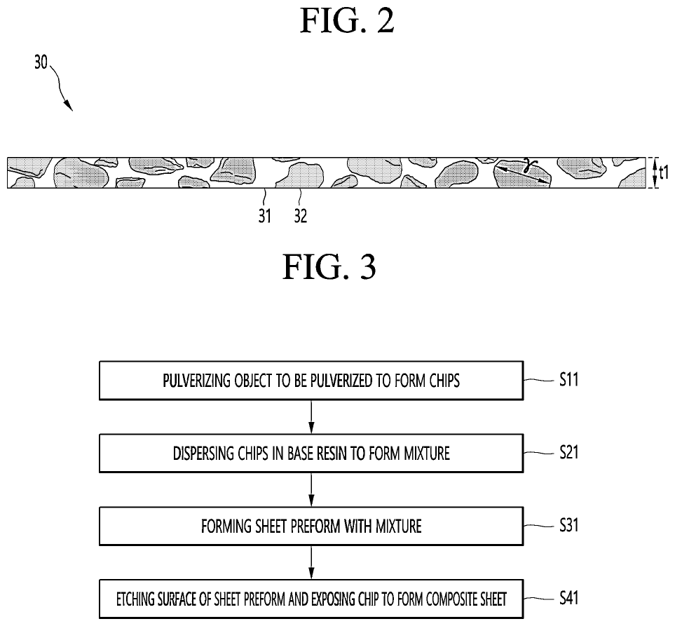

FIG. 1 is a front view illustrating a home appliance according to one embodiment and FIG. 2 is a cross-sectional view illustrating a composite sheet according to one embodiment.

Hereinafter, a home appliance 1 to which the composite sheet 30 according to the present disclosure can be applied will be described with reference to FIGS. 1 and 2. In this disclosure, the description is based on the refrigerator 1 as an example of the home appliance 1, but the home appliance 1 is not limited thereto and the present disclosure can be applied to other types of home appliances 1 including an air conditioner, an air purifier, a vacuum cleaner, a cooking device, a dishwasher, a clothes care machine, a washing machine, and the like.

The home appliance 1 according to an embodiment of the present disclosure can have an outer appearance formed by a cabinet 10 forming a storage space and a door 20 opening and closing the storage space of the cabinet 10.

For example, the cabinet 10 can form a storage space divided into upper and lower sections, and a refrigerating chamber 11 can be formed at the upper portion and a freezing chamber 12 can be formed at the lower portion.

The door 20 can include a refrigerating chamber door 21 that opens and closes the refrigerating chamber 11 and a freezing chamber door 22 that opens and closes the freezing chamber 12. For example, the refrigerating chamber door 21 can be referred to as a first door, and the freezing chamber door 22 can be referred to as a second door. But embodiments of the present disclosure are not limited thereto.

The refrigerating chamber door 21 can be rotatably connected to the cabinet 10 by a hinge and can be a rotary door that opens and closes the refrigerating chamber 11 by rotation. Additionally, the freezing chamber door 22 can also be rotatably connected to the cabinet 10 by a hinge and configured to open and close the freezing chamber 12 by rotation. However, the freezing chamber door 22 is not limited to this and can be configured to be pulled in and out in a drawer style to open and close the freezing chamber 12.

Of course, in this embodiment, for convenience of explanation and understanding, the refrigerator 1 is described as an example in which the refrigerating chamber is disposed at the upper portion and the freezing chamber 12 is disposed at the lower portion, but the present disclosure is not limited to the form of the refrigerator 1 and can be applied to any type of refrigerator 1 equipped with a door.

The freezing chamber door 22 can include a composite sheet 30 that constitutes the outer appearance of the front surface. The composite sheet 30 can have a flat plate shape with a first thickness t1. The composite sheet 30 can be coupled to the front surface of the door body of the freezing chamber door 22. Here, the composite sheet 30 can be referred to as a door cover. For example, the composite sheet 30 can be attached to the door body through an adhesive member disposed between the door body and the composite sheet. The adhesive member can be disposed along the edge of the composite sheet 30. The adhesive member can be a double-sided adhesive tape or a magnet, but is not limited thereto and can be determined in various ways according to the material of the door body.

The first thickness t1 of the composite sheet 30 can be adjusted in various ways through surface etching. For example, the first thickness t1 of the composite sheet 30 can be adjusted in various ways by cutting the surface. As an example, the first thickness t1 of the composite sheet 30 can be 3 mm or more and 10 mm or less.

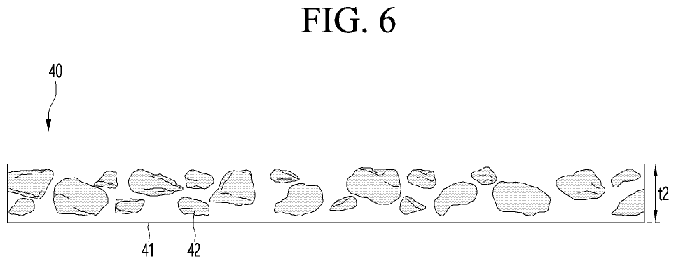

The composite sheet 30 can include a matrix 31 and a plurality of chips 32 surrounded by the matrix 31. A plurality of chips 32 can be distributed and disposed in the matrix 31. At least a portion of the plurality of chips 32 can be exposed to the outside. Additionally, the plurality of chips 32 can have an irregular shape as shown in FIGS. 2 and 6, but embodiments of the present disclosure are not limited thereto, and each of the plurality of chips 32 can have a regular shape, a pattern or a form that regular, such as a geometric shape. The above structure can be formed by etching a sheet-shaped sheet preform 40 (see FIG. 6) formed by mixing the material forming the matrix 31 and a plurality of chips 32. The surface of the composite sheet 30 can be etched and then polished, so that the surface of the composite sheet 30 can have an arithmetic average roughness of 2 μm or more and 3 μm or less.

In the composite sheet 30, the plurality of chips 32 can be etched and exposed to the outside. The size r of the chip 32 can mean the maximum length among the arbitrary lengths of each chip 32. The size r of the chip 32 can be 1 mm or more and 3 cm or less. In order to form the sheet preform 40 of the composite sheet 30 having a certain thickness and expose the plurality of chips 32 to the outside through etching, it can be advantageous for the size of the chips 32 to be 1 mm or more. Meanwhile, after forming the sheet preform 40, the composite sheet 30 can be formed through etching and in this case, in order for the etching to occur smoothly, it can be advantageous for the size r of the chip 32 to be 3 cm or less.

For example, the average value of the size r of the plurality of chips 32 can be 1 mm or more and 3 cm or less, 2 mm or more and 2 cm or less, 3 mm or more and 1 cm or less, or 4 mm or more and 6.7 mm or less, but embodiments of the present disclosure are not limited thereto, and other average values of the size r are possible.

The first thickness t1 of the composite sheet 30 can be adjusted to be smaller than the average size r of the plurality of chips 32. Accordingly, chips 32 can be exposed on the surface of the composite sheet 30. In the composite sheet 30, the number of chips 32 entirely surrounded by the matrix 31 can be smaller than the number of chips 32 at least partially exposed to the outside. For example, the number of chips 32 exposed on the surface of the composite sheet 30 can be 50% or more, 60% or more, 70% or more, 80% or more, or 90% or more based on the total number of chips 32. But embodiments of the present disclosure are not limited thereto. Also, an area of the chips 32 exposed (i.e., an exposed area) on the surface of the composite sheet 30 or the matrix 31 can be about 10% or more and about 95% or less of an entire surface area (i.e., a total area) of the composite sheet 30 or the matrix 31. Thus, a ratio of the exposed area to the total area can be about 0.10 to about 0.95. In various embodiments of the present disclosure the ratio of the exposed area to the total area can be about 0.2, 0.3, 0.4, 0.5, 0.6, 0.7, 0.8 or 0.9, or any ratio between 0.10 to 0.95.

In various embodiments of the present disclosure, an arrangement or distribution of the plurality of chips 32 that are exposed on the surface of the composite sheet 30 can be regular, periodic, irregular, random or any combination thereof. For example, the arrangement or distribution of the plurality of chips 32 that are exposed on the surface of the composite sheet 30 can be entirely periodic, entirely irregular, entirely random, or can be mixed where some of the arrangement or distribution of the plurality of chips 32 can be regular and/or periodic, and some of the arrangement or distribution of the plurality of chips 32 are irregular and/or random.

In various embodiments of the present disclosure, the first thickness t1 of the composite sheet 30 need not be adjusted to be smaller than the average size r of the plurality of chips 32. Rather, the first thickness t1 of the composite sheet 30 can be about the same or be greater than the average size r of the plurality of chips 32. Additionally, the size of the plurality of chips 32 can all be the same in various embodiments of the present disclosure, or a first group of the plurality of chips 32 can have the same size, while a second group of the plurality of chips 32 can have different sizes, and the first group and the second group of the plurality of chips 32 can be mixed in the composite sheet 30.

In various embodiments of the present disclosure, the plurality of chips 32 can overlap one another in a thickness direction of the composite sheet 30, but such is not required. In various embodiments of the present disclosure an amount or density of overlap between the plurality of chips 32 can be less than 100 per a sample of the composite sheet 30. A sample of the composite sheet 30 can be 10 cm by 10 cm. In other embodiments, the amount or density of overlap between the plurality of chips 32 can be less than 50, less than 25, less than 10, less than 5, or can be none. But embodiments of the present disclosure are not limited thereto, and an overlap of 100 or more per the sample is also possible.

As described above, the composite sheet 30 can have an outer appearance with a plurality of chips 32 exposed to the matrix 31. Accordingly, the composite sheet 30 can be referred to as a terrazzo sheet having a terrazzo pattern with a marble-like texture. Meanwhile, terrazzo patterns are attracting attention as patterns that form interior decoration or the outer appearance design of products as they can reproduce the texture and feel of natural marble and create a luxurious atmosphere.

The chips 32 included in the composite sheet 30 can be formed by pulverizing waste materials. Therefore, the composite sheet 30 according to one embodiment can form a terrazzo pattern by recycling waste materials, thereby improving the aesthetics and eco-friendliness of the applied product at the same time. In other words, the composite sheet 30 according to one embodiment can provide upcycling value to the home appliance 1 applied to the outer appearance.

In various embodiments of the present disclosure, waste material can include post-consumer products or recyclable materials, including metal, paper, plastics, wood, or other materials that can be re-used or repurposed, but can also include a combination of such post-consumer products or recyclable materials with an amount of new materials or materials that have been recycled.

In addition, the composite sheet 30 can have a composite structure including the chip 32, so that it can have high surface hardness, high strength, and low thermal expansion coefficient compared to the plastic material commonly used for the outer appearance of the home appliance 1. Accordingly, the home appliance 1 to which the composite sheet 30 can be applied can have improved durability against the external environment.

Therefore, the composite sheet 30 can be used not only as a home appliance 1 but also as a construction material and building material. For example, the composite sheet 30 can be used as an indoor material for interior decoration.

Hereinafter, each component included in the composite sheet 30 will be described.

The matrix 31 can have a sheet shape and can be made of a material that can be easy to process. Matrix 31 can include a thermoplastic resin. The matrix 31 can be included in an amount of 65 parts by weight or more and 85 parts by weight or less based on 100 parts by weight of the total weight of the composite sheet 30.

For example, the matrix 31 can be made of polymethyl methacrylate (PMMA), polycarbonate (PC), acrylonitrile butadiene styrene (ABS), and polyethylene terephthalate (PET), polyamide (PA), polypropylene (PP), and polystyrene (PS).

In the composite sheet 30, the chip 32 can be fixed to the matrix 31. The chip 32 can include a highly heat-resistant material. The chip 32 can be made of a material that does not melt into the matrix 31 during the process of manufacturing the sheet preform 40 through methods such as casting, extrusion, and injection. The melting point of the chip 32 can preferably be 200° C., or higher.

Chips 32 can be formed by pulverizing waste materials. For example, the waste can be any one of artificial marble, super engineering plastic, thermosetting plastic, and high heat-resistant bio material. In other words, the chip 32 can be formed by pulverizing any one of artificial marble, super engineering plastic, thermosetting plastic, and high heat-resistant bio material. The chips 32 can be included in an amount of 8 parts by weight or more and 30 parts by weight or less based on 100 parts by weight of the total weight of the composite sheet 30. In various embodiments of the present disclosure, reference to a high heat-resistant bio material can refer to a material that can have a melting point of about 200° C., or higher.

Hereinafter, examples of the above-described materials that can be used as the chip 32 will be described.

Artificial marble can be commercial artificial marble. For example, artificial marble can include 35 parts by weight or more and 65 parts by weight or less of aluminum hydroxide, 25 parts by weight or more and 45 parts by weight or less of methylmethacrylate (MMA), 8 parts by weight or more and to 30 parts by weight or less of polymethylmethacrylate (MMA), 0.5 parts by weight or more and 5 parts by weight or less of ethylene glycol dimethylacrylate (EGDMA) based on 100 parts by weight of the total weight.

In the case of artificial marble, the plastic material included in the chip 32 can chemically combine with the material forming the matrix 31 in a high-temperature environment created during processes such as casting, extrusion, and injection to form a sheet shape. For example, in a high-temperature environment, materials such as methyl methacrylate (MMA) or polymethyl methacrylate (PMMA) contained in artificial marble can chemically bond with the materials forming the matrix 31. Accordingly, the bonding strength between the chip 32 and the matrix 31 can be improved.

Super engineering plastic can include at least one of polyether ether ketone (PEEK), polytetrafluoroethylene (PTFE), polyamide imide (PAI), and polyimide (PI).

In the case of super engineering plastic, the plastic material contained in the chip 32 can chemically bond with the material forming the matrix 31 in a high temperature environment formed during processes such as casting, extrusion, and injection to form a sheet shape. For example, in a high-temperature environment, material such as polyether ether ketone (PEEK), polytetrafluoroethylene (PTFE), polyamide imide (PAI), or polyimide (PI) included in the super engineering plastic can chemically bond with the materials forming the matrix 31. Accordingly, the bonding strength between the chip 32 and the matrix 31 can be improved.

Thermosetting plastic can include at least one of phenol resin, urea resin, melamine resin, epoxy resin, urea resin, unsaturated polyester resin, alkyd resin, silicon resin, and polyurethane resin.

High heat-resistant biomaterials can include waste shells such as oyster shells, clam shells, abalone shells, conch shells, or others. In various embodiments of the present disclosure, the high heat-resistant biomaterials can include some portions of the waste shells such as nacre or a portion including the nacre. The highly heat-resistant bio material can contain 89 parts by weight or more and 99 parts by weight or less of calcium carbonate (CaCO₃) based on the total weight.

As will be described later, when the material forming the chip 32 is a thermosetting plastic or a highly heat-resistant bio material, the composite sheet 30 can further include maleic anhydride.

The composite sheet 30 can further include pigment. Pigments can be added to impart color to the composite sheet 30. For example, titanium dioxide (TiO₂) can be added to give white color to the composite sheet 30, and a mixture of titanium dioxide (TiO₂) and Chrome antimony titanium buff rutile (C.I. Pigment Brown 24) can be added to give yellow color and a mixture of titanium dioxide (TiO₂), blue pigment of Solvent Blue 97, and red pigment of ferric oxide can be added to give indigo color. The pigment can be included in an amount of 4 parts by weight or more and 6 parts by weight or less based on 100 parts by weight of the total weight of the composite sheet 30.

The composite sheet 30 can further include a UV stabilizer. For example, the UV stabilizer can include at least one of a polymer UV absorber, a hydroxyphenol benzotriazole series UV absorber, and Tinuvin-P. The UV stabilizer can be included in an amount of 1 part by weight or more and 2 parts by weight or less based on 100 parts by weight of the total weight of the composite sheet 30.

The composite sheet 30 can further include maleic anhydride according to the material of the chip 32. Maleic anhydride can be added to increase the bonding strength between the materials forming the matrix 31 and the materials forming the chip 32 when the chemical bonding strength between them is weak. For example, maleic anhydride can be added when the material making up the chip 32 is thermosetting plastic or a highly heat-resistant bio material. For example, maleic anhydride can be included in an amount of 1 part by weight or more and 3 parts by weight or less based on 100 parts by weight of the total weight of the composite sheet 30.

The composite sheet 30 according to one embodiment can provide upcycling value that simultaneously improves aesthetics and eco-friendliness to the home appliance 1 applied using eco-friendly materials.

The composite sheet 30 according to one embodiment can have a structure including a matrix 31 and a chip 32, which can improve mechanical properties such as improving surface hardness, improving strength, and reducing thermal expansion coefficient of the home appliance 1 to which the composite sheet 30 is applied.

The composite sheet 30 according to one embodiment can have a structure with improved heat resistance including chips 32 made of a high heat resistance material, which prevents the product to which the composite sheet 30 is applied from burning from heat in the event of a fire so that user safety can be improved.

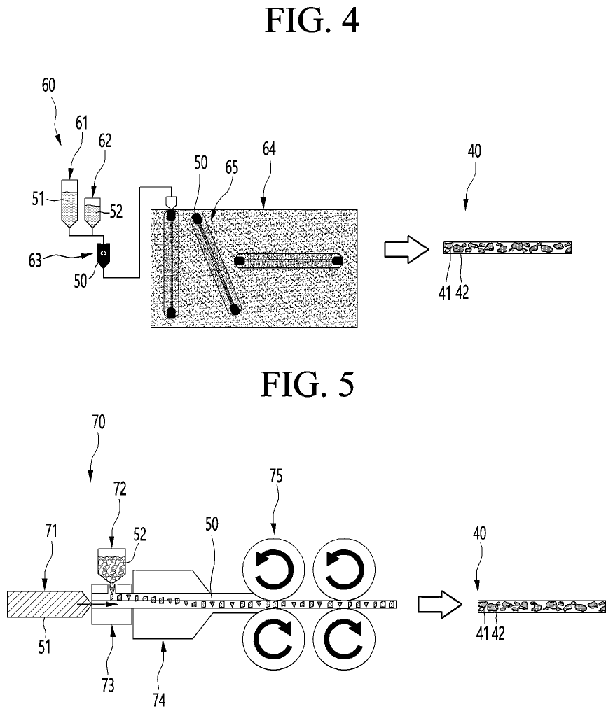

FIG. 3 is a flowchart illustrating a method for manufacturing a composite sheet according to one embodiment, FIG. 4 is a schematic diagram illustrating a process of casting a sheet preform according to one embodiment, FIG. 5 is a schematic diagram illustrating the process of extruding a sheet preform according to one embodiment, and FIG. 6 is a cross-sectional view illustrating a sheet preform according to one embodiment.

Referring to FIGS. 3 to 6, the method for manufacturing a composite sheet according to an embodiment can include a step S11 of pulverizing an object to be pulverized to form chips, a step S21 dispersing the chips in a base resin to form a mixture, a step S31 forming a sheet preform using the mixture, and a step S41 forming a composite sheet by etching the surface of the sheet preform to expose chips.

First, the step (S11) of pulverizing the object to be pulverized to form chips can be performed. The object to be pulverized can be a waste material. The waste material can be any one of artificial marble, super engineering plastic, thermosetting plastic, and high heat-resistant bio material.

Pulverizing of the object to be pulverized can be performed until the size r of the chip 32 reaches a certain level. The size r of the chip 32 can be 1 mm or more and 3 cm or less. In order to form the sheet preform 40 of the composite sheet 30 having a certain thickness and expose the plurality of chips 32 to the outside through etching, it can be advantageous for the size of the chips 32 to be 1 mm or more. Meanwhile, after forming the sheet preform 40, the composite sheet 30 can be formed through etching and in this case, in order for the etching to occur smoothly, it can be advantageous for the size r of the chip 32 to be 3 cm or less.

For example, the average size r of the plurality of chips 32 can be 1 mm or more and 3 cm or less, 2 mm or more and 2 cm or less, 3 mm or more and 1 cm or less, or 4 mm or more and 6.7 mm or less.

After the step S11 of pulverizing the object to be pulverized to form chips, a step S21 of dispersing the chips in the base resin to form a mixture can be performed. The pulverized chips 32 can become the chips 32 of the composite sheet 30, and the base resin 51 can become the matrix 31 of the composite sheet 30.

The step S21 of forming a mixture by dispersing the chips in the base resin can further include a step of adding maleic anhydride according to the material of the pulverized chips 52 used. Maleic anhydride can be added to increase the bonding strength between the base resin 51 and the pulverized chip 52 when the chemical bonding strength between them is weak. For example, maleic anhydride can be added when the material making up the pulverized chip 52 is thermosetting plastic or a highly heat-resistant bio material. For example, maleic anhydride can be included in an amount of 1 part by weight or more and 3 parts by weight or less based on 100 parts by weight of the total weight of the mixture.

After the step S21 of dispersing in the base resin to form a mixture, the step S31 of forming a sheet preform using the mixture can be performed. This step S31 and the step S21 of dispersing in the base resin to form a mixture can be performed together.

This step S31 can be performed by various sheet forming processes such as casting, extrusion, and injection. The sheet forming process, such as casting, extrusion, and injection, can include a step of heating to a temperature of 200° C. or less. This step will be described with reference to FIGS. 4 and 5. The step of forming the sheet preform 40 through a casting process will be described with reference to FIG. 4, and the step of forming the sheet preform 40 through an extrusion process will be described with reference to FIG. 5.

Referring to FIG. 4, a step of forming the sheet preform 40 through a casting process can be performed through the casting system 60. As an example, the casting system 60 can include a first storage part 61 in which the base resin 51 is stored, a second storage part 62 in which the pulverized chips 52 are stored, a mixing part 63 in which the base resin 51 and the pulverized chips 52 are mixed into a mixture 50, a water tank 64 in which the sheet preform 40 is hardened, and a casting 65 that forms the shape of the sheet preform 40.

The casting process can be performed at high temperatures of 200° C. or lower. Accordingly, the step of forming the sheet preform 40 through a casting process can include a step of heating the mixture 50. The melting point of the crushed chips 52 can be higher than the casting process temperature. Therefore, during the casting process, the chip 52 can maintain the shape thereof without melting in the base resin 51.

The base resin 51 stored in the first storage part 61 and the pulverized chips 52 stored in the second storage part 62 can be supplied to the mixing part 63. The base resin 51 and the pulverized chips 52 supplied to the mixing part 63 can be mixed to form the mixture 50. The mixture 50 can be put into a casting to take the shape of a sheet preform 40. The mixture 50 added to the casting 65 can be hardened in the water tank 64. When curing is complete, the sheet preform 40 can be formed. The sheet preform 40 will be described later with reference to FIG. 6.

Referring to FIG. 5, the step of forming the sheet preform 40 through an extrusion process can be performed through an extrusion system 70. As an example, the extrusion system 70 can include a first storage part 71 in which the base resin 51 is stored, a second storage part 72 in which the pulverized chips 32 are stored, a mixing part 73 in which the base resin 51 and the pulverized chips 32 are mixed, a moving part 74 in which the mixture 50 is moved, and an extrusion part 75 in which the mixture 50 is extruded to form the sheet preform 40.

The extrusion process can be performed at high temperatures of 200° C. or lower. Accordingly, the step of forming the sheet preform 40 through an extrusion process can include a step of heating the mixture 50. The melting point of the pulverized chips 52 can be higher than the extrusion process temperature. Therefore, during the extrusion process, the chip 52 can maintain the shape thereof without melting into the base resin 51.

The base resin 51 stored in the first storage part 71 and the pulverized chips 32 stored in the second storage part 72 can be supplied to the mixing part 73. The base resin 51 and the pulverized chips 32 supplied to the mixing part 73 can be mixed to form the mixture 50. The mixture 50 can be provided to the extrusion part 75 through the moving part 74. The mixture 50 can be extruded through the extrusion part 75 to form the sheet preform 40.

Referring to FIG. 6, the sheet preform 40 can include a matrix preform 41 and a plurality of chips 42 surrounded by the matrix preform 41. In the sheet preform 40, the number of chips 42 entirely surrounded by the matrix preform 41 can be greater than the number of chips 42 at least partially exposed to the outside. For example, the number of chips 42 exposed on the surface of the sheet preform 40 can be less than 50%, less than 40%, less than 30%, less than 20% or less than 10% based on the total number of chips 42.

The sheet preform 40 can have a second thickness t2. The second thickness t2 can be greater than the composite sheet 30, which is the final product. In other words, the thickness of the sheet preform 40 can be reduced through subsequent processing to change into a composite sheet 30 having a first thickness t1. The second thickness t2 can be larger than the size r of the chip 42. Accordingly, in the sheet preform 40, the number of chips 42 entirely surrounded by the matrix preform 41 can be greater than the number of chips 42 at least partially exposed to the outside.

After a step S31 of forming a sheet preform 40 using the mixture, a step S41 of forming a composite sheet 30 by etching the surface of the sheet preform 40 to expose chips 32 can be performed. Through this step, the sheet preform 40 having a second thickness t2 can be changed into a composite sheet 30 having a first thickness t1 smaller than the second thickness t2. In this step, the surface etching of the sheet preform 40 can be performed on both sides of the sheet preform 40. Accordingly, the chip 32 can be exposed on both sides of the composite sheet 30 formed after this step, and the terrazzo pattern can be confirmed. But embodiments of the present disclosure are not limited thereto, and only one side of the composite sheet 30 can be etched to expose the chip 32 while the other side is not etched or only minimally processed.

As the sheet preform 40 is changed into the composite sheet 30 through this step, the number of chips 32, at least some of which are exposed to the outside, can increase. When the surface of the sheet preform 40 is etched, the matrix preform 41 and the chip 42 can be etched to form a flat surface. In other words, in the composite sheet 30, the exposed surface of the matrix 31 and the exposed surface of the chip 32 can be aligned with each other.

After the surface etching step of the sheet preform 40, a surface polishing step of polishing the roughened surface through surface etching can be further performed. Through this, the arithmetic average roughness of the surface of the composite sheet 30 can be secured to be 2 μm or more and 3 μm or less.

According to the method for manufacturing the composite sheet 30 according to an embodiment, upcycling value that the composite sheet 30 is manufactured using eco-friendly materials to simultaneously improve aesthetics and eco-friendliness in the home appliance 1 to which the composite sheet 30 is applied can be given.

According to a method for manufacturing a composite sheet according to an embodiment, a composite sheet 30 having a structure including a matrix 31 and a chip 32 is manufactured, and thus the mechanical properties of the home appliance 1 to which the composite sheet 30 is applied can be improved, such as improved surface hardness, improved strength, and reduced thermal expansion coefficient.

According to a method for manufacturing a composite sheet according to an embodiment, a composite sheet 30 having a structure with improved heat resistance including chips 32 made of a high heat resistance material is manufactured, and thus in the event of a fire, the product to which the composite sheet 30 is applied can be prevented from burning from heat, thereby improving user safety.

What is claimed is:

1. A composite sheet comprising:
a matrix including a base resin containing a thermoplastic material; and
a plurality of chips including waste materials having irregular shapes, and coupled to the matrix,
wherein the plurality of chips are partially exposed to an outer surface of the composite sheet, and
wherein sizes of the plurality of chips range from about 1 mm to about 3 cm, and a melting point temperature of the plurality of chips is about 200° C. or greater.

2. The composite sheet of claim 1, wherein the matrix includes at least one of polymethyl methacrylate (PMMA), polycarbonate (PC), acrylonitrile butadiene styrene (ABS), polyethylene terephthalate (PET), polyamide (PA), polypropylene (PP), and polystyrene (PS).

3. The composite sheet of claim 1, wherein the plurality of chips are formed by pulverizing the waste materials.

4. The composite sheet of claim 3, wherein a waste material of the waste materials includes artificial marble.

5. The composite sheet of claim 3, wherein a waste material of the waste materials includes a material containing at least one of polyether ether ketone (PEEK), polytetrafluoroethylene (PTFE), polyamide imide (PAI), and polyimide (PI).

6. The composite sheet of claim 3, further comprising:
maleic anhydride,
wherein a waste material of the waste materials includes a thermosetting plastic containing at least one of phenol resin, melamine resin, epoxy resin, urea resin, unsaturated polyester resin, alkyd resin, silicon resin, and polyurethane resin.

7. The composite sheet of claim 3, further comprising:
maleic anhydride,
wherein a waste material of the waste materials includes a shell.

8. The composite sheet of claim 3, wherein the outer surface of the composite sheet having the plurality of the chips that are partially exposed has an arithmetic average roughness of about 2 μm to about 3 μm.

9. The composite sheet of claim 8, wherein a number of the plurality of chips exposed to the outer surface of the composite sheet is about 50% or greater of an entire surface of the composite sheet.

10. A method for manufacturing a composite sheet, the method comprising:
pulverizing waste materials with a melting point temperature of about 200° C. or greater to form a plurality of chips having irregular shapes and a size range of about 1 mm to about 3 cm;
mixing the plurality of chips in a base resin to form a mixture;
manufacturing a sheet preform by heating the mixture; and
cutting an outer surface of the sheet preform to partially expose the plurality of chips to an outer surface of the composite sheet.

11. The method for manufacturing a composite sheet of claim 10, wherein the base resin includes a thermoplastic material.

12. The method for manufacturing a composite sheet of claim 11, wherein the base resin includes at least one of polymethyl methacrylate (PMMA), polycarbonate (PC), acrylonitrile butadiene styrene (ABS), polyethylene terephthalate (PET), polyamide (PA), polypropylene (PP), and polystyrene (PS).

13. The method for manufacturing a composite sheet of claim 10, wherein a waste material of the waste materials includes artificial marble.

14. The method for manufacturing a composite sheet of claim 10, wherein a waste material of the waste materials includes a material containing at least one of polyether ether ketone (PEEK), polytetrafluoroethylene (PTFE), polyamide imide (PAI), and polyimide (PI).

15. The method for manufacturing a composite sheet of claim 10, wherein a waste material of the waste materials includes thermosetting plastics containing at least one of phenol resin, melamine resin, epoxy resin, urea resin, unsaturated polyester resin, alkyd resin, silicon resin, and polyurethane resin, and
wherein the mixing of the plurality of the chips in the base resin to form the mixture further includes adding maleic anhydride.

16. The method for manufacturing a composite sheet of claim 10, wherein a waste material of the waste materials include a shell, and
wherein the mixing of the plurality of the chips in the base resin to form the mixture further includes adding maleic anhydride.

17. The method for manufacturing a composite sheet of claim 10, wherein the cutting the outer surface of the sheet preform increases a number of the plurality of chips exposed to the outer surface of the composite sheet.

18. A home appliance comprising:
a cabinet forming a storage space;
a door configured to open and close access to the storage space; and
a door cover coupled to a front of the door,
wherein the door cover includes the composite sheet of claim 1.

19. A composite sheet comprising:
a matrix; and
a plurality of chips dispersed in the matrix,
wherein the plurality of chips are partially exposed to an outer surface of the matrix, and
wherein a ratio of an area of the plurality of chips exposed to the outer surface of the matrix and an entire surface area of the matrix is about 0.50 or greater.

20. The composite sheet of claim 19, wherein sizes of the plurality of chips range from about 1 mm to about 3 cm, and a melting point temperature of the plurality of chips is about 200° C. or greater.
